(19) United States
(12) Patent Application Publication
(10) Pub. No.: US 2016/0247638 A1
(43) Pub. Date: Aug. 25, 2016

(54) ELECTRICAL CONTACTS WITH A REDUCED ALUMINUM SECTION

(71) Applicant: Mikhail SOTNIKOV, Saint Bruno, Quebec (CA)

(72) Inventor: Mikhail Sotnikov, Saint Bruno, Quebe (CA)

(21) Appl. No.: 15/022,975

(22) PCT Filed: Nov. 17, 2014
(86) PCT No.: PCT/CA2014/000825

§ 371 Date: Mar. 18, 2016

(30) Foreign Application Priority Data
Nov. 15, 2013 (MX) MX/A/2013/013363

(51) Int. Cl. H01H 1/021; H01H 1/50; H01H 1/36

(52) U.S. Cl. CPC H01H 1/021; H01H 1/36; H01H 1/50; H01H 2235/01

(57) ABSTRACT

Electrical contacts with a reduced section for use in high-voltage switches, the contacts are produced by machining or by extrusion. The contacts are designed to be used outdoors, indoors, in vacuum or in any other inert atmosphere for electrical switching equipment without additional pressure system or with additional pressure system. The contacts can be used in linear movement, radial movement, or any other type of movement or sliding. The contacts can be used in various shapes, such as contact pins or tulip shapes, partial tulips, or rectangular tulips, or they can be used as the single pressure element for the electrical contact. The contacts are designed to cooperate electrically with opposing contact parts. The contacts can interrupt a physical link with an opposing contact or they can remain in constant contact during the operating movement. The contacts are made from aluminum alloys, with or without contact surfaces. A contact assembly can use the same base materials or different base materials. The contacts can be used as an intermediary between copper and aluminum parts in the switch to prevent corrosion due to the electrochemical potential difference of the materials.

### CROSS REFERENCE TO RELATED APPLICATIONS

This application claims the priority and benefit of International Patent Application PCT/CA2014/000825 filed Nov. 17, 2014, which claims priority and benefit to Mexican Patent Application No. MX/a/2013/013363 filed Nov. 15, 2013; the entireties of which are incorporated herein by reference in their entirety and for all purposes.

### FIELD OF THE INVENTION

This invention concerns electrical switching devices, in particular, electrical contacts used in circuit breakers.

### PRIOR ART

Electrical distribution networks are protected and controlled by medium and high-voltage breakers.

The breakers have a stable function of interrupting the flow of electric current in the lines. The electrical contacts play an important and critical role in the proper operation of the breaker.

A switch is a device for disconnecting the electricity from a source or electrical network for cutoff in separate sections and it is designed to resist a certain overload or short circuit without damage. Unlike fuses, which operate a single time and then have to be replaced, it is designed for multiple operations.

The electrical contact is obtained by placing two conductor objects in physical contact. This can be done in various ways. Even though there is a broad variety of contact designs in the interrupting chambers, the basic contacts:

1. Can open or close with mechanical loading;

2. Can be displaced, while maintaining the contact during the corresponding movement.

3. Can be fixed permanently for years and never be opened.

4. Are removable—these can open or close without load, and they are generally used in medium-voltage shielded distribution boxes.

The contact in the present invention is designed to cooperate with the opposing electrical contact under a certain pressure. The pressure can be provided via the elastic deformation of the contact, additional pressure systems, or by elastic deformation and additional pressure systems. This electrical contact is to be used in high-voltage and high-current electrical devices.

The contacts of reduced section function as follows: to move the contacts a certain distance, a certain force is needed, after they move they will be maintained by force in the way that a spring operates. Even so, the contacts of the invention also conduct electricity. Therefore, they can be considered to be a contact spring.

The reduced section also:

1. Enables a greater movement with a small force (for example, if we cannot use thinner material, since it will not be able to conduct the necessary current). In these cases, even if the current is of high density in the reduced section, other parts of the contact play the part of dissipating/absorbing heat to ensure that the contact does not become overheated.

2. Moves the contacts in the necessary direction. The place where the reduced section is located will determine how the contact bends and in what direction.

3. The contact is under low pressure only if it is displaced. The pressure will be provided by the elastic deformation of the aluminum, which means that after the moving part is eliminated, the contact returns to its original position/shape. The difference between plastic and elastic deformation is that plastic deformation requires an additional force for the contact to return to the original position/condition; the structure of aluminum has excellent mechanical properties and can be used in the zone of elastic deformation. Here once more is the important.

4. Without the reduced section, the mechanical tension/stress is concentrated in the same place (at the side of the apparatus and in the direction opposite the application of the force/movement), and may lead to the destruction/failure of the contact.

A first objective of the invention is to provide a high-voltage disconnection breaker with electrical contacts which is highly flexible, without additional spring systems. The shape of the reduced section and the thickness will provide an electrical contact with safe physical properties that result in high efficiency during service, such as: high capacity to adapt to the misalignment of the components, low contact temperature, resistance to high current during short circuits in electrical devices. The contact section will have a safe material section for the transfer of electric current; the mass/section/size of the contact in general will have a function of absorbing the heat generated by the current or the short circuit current in the reduced section of the aluminum contact.

Another objective of the invention is to provide a high-voltage disconnection switch with electrical contact which is highly flexible and adaptable to the opposing contact part in order to provide an assembly with fully calculated contact parameters. The shape of the reduced section as well as the thickness, whether alone or combined with the additional pressure systems, will provide the electrical contacts with a safe physical contact area that will be highly adaptable to the misalignment of the components in the electrical devices. The contact section will have a safe section for the transfer of the electric current, and the additional contact mass will have a role of absorbing the heat generated by the high current density in the aluminum contacts.

Another objective of the invention is to provide electrical contacts with a reduced section of aluminum which utilizes the mechanical properties of aluminum as an element of supplying pressure to the whole.

Another objective of the invention is to provide electrical contacts with a reduced section of aluminum to have sufficient flexibility obtained from the reduction in the aluminum cross section of the contacts.

Another objective of the invention is to provide electrical contacts with a reduced aluminum section with the ability to withstand the thermal shock and the electrodynamical forces during the exposure to the short circuit current.

Another objective of the invention is to provide electrical contacts with a reduced aluminum section able to prevent any risk of creating a fusion between the contact and the opposing part of the contact when the contacts are subjected to a short circuit.

Another objective of the invention is to provide electrical contacts with a reduced aluminum section to prevent any plastic deformation in event of short circuits and therefore to limit the movement through it or through additional integrated devices.

Another objective of the invention is to provide electrical contacts with a reduced aluminum section which are able to maintain a low contact resistance during prolonged periods of time during stationary operation in the closed position.

Another objective of the invention is to provide electrical contacts with a reduced aluminum section with equal contact force in the contact assembly for each contact element.

Another objective of the invention is to provide electrical contacts with a reduced aluminum section with the ability to prevent a plastic rebound of the materials of the pins during the movement of the contact cycle of the pins.

Another objective of the invention is to provide electrical contacts with a reduced aluminum section with the ability to eliminate the contact movement and the degradation of the contact due to micro arc erosion.

Another objective of the invention is to provide electrical contacts with a reduced aluminum section to distribute the mechanical deformation stress of the aluminum through the reduced section, including multiple spherical reductions, multiple angular ones, and angular deformations.

Another objective of the invention is to provide electrical contacts with a reduced aluminum section as a function of the application with an inward deflection, as well as on the outside of the fixed contact part.

Another objective of the invention is to provide electrical contacts with a reduced aluminum section with the ability to increase the contact pressure during the short circuit by moving to the zone of greater contact pressure during the electromechanical force generated by short circuit.

Another objective of the invention is to provide electrical contacts with a reduced aluminum section, with a limited movement which can be achieved by the concept of contact with itself or with elements which limit the additional movement being integrated therein.

Another objective of the invention is to provide electrical contacts with a reduced aluminum section with the ability to adapt to the misalignment via the flexibility of the contacts provided in the reduced aluminum section.

Another objective of the invention is to provide electrical contacts with a reduced aluminum section in order to have a heat dissipation behind the contact zone, in order to absorb and distribute the heat generated by the rated current and/or the short circuit current.

Another objective of the invention is to provide a reduced aluminum section electrical contact with the additional benefits of the mechanical forces generated by the passage of the opposite electric current.

These objectives are accomplished by providing electrical contacts with a reduced aluminum section of the invention with a usable contact pressure that can be calculated precisely, the contact area, the contact surface shapes which are highly adaptable to poorly aligned assemblies, the maintaining of the precise contact pressure, limited contact movement, high conductivity of the materials of the components, the highly efficient elimination of oxides during the displacement movement, the use of the floating pressure distribution.

### BRIEF DESCRIPTION OF THE INVENTION

The aforementioned electrical contacts with a reduced section of aluminum of the invention are designed to work against the opposing part of the contact, which can also be electrical contacts with a reduced section of aluminum. To maintain the sliding of a certain type between the surfaces is an essential requirement. The area of application of electrical contacts with a reduced section of aluminum is high-voltage equipment (isolator switch) for use indoors and outdoors.

The length of the reduced section will play an essential role in the providing of a contact with flexibility and adaptability and in allowing the whole to accommodate a certain degree of misalignment of the components during the assembly process.

The actuating force of the sliding contact is defined as not more than 10 kg per mm of linear length of the contact in the case of using solid silver for the contact surfaces.

The aluminum section, the shape and the length of the reduced section of the contact will play the main role in determining the contact force of the electrical contact with any given displacement.

To obtain an additional short circuit performance, electrical contacts with a reduced section of aluminum of the invention can have a variety of metal surface coatings, and the use of aluminum as an additional absorber of heat. Metallic surface coatings will be selected according to the practical use of the contact.

Various multiple spring systems can be used to provide the contacts with additional pressure if necessary, high-voltage compression springs, Bellville springs, and closed-circuit voltage spring systems.

The combination of a surface coating and the calculated pressure for the whole provides a contact with a low operating force, stable contact resistance and low operating temperature.

Based on the data for electrical contacts with a reduced section of aluminum of the invention there needs to be provided:

Rated working current: contact assembly with the reduced aluminum contact section designed for 1 A/mm² of the section of the base material with a current density of up to 4.5 A/mm² in the smallest part of the reduced section.

Short circuit current: contact assembly with the reduced aluminum contact section designed for 1 A/mm² of the section of the base material with a current density of up to 45 A/mm² in the smallest part of the reduced section.

The working pressure should be between: 3 kgf/mm and 5 kgf/mm.

The elastic deformation of the aluminum should be at a minimum factor of 1.25 in the end position of the pins at a temperature of 115° C.

Maximum temperature should not be more than 220° C.

This invention provides an aluminum contact with a reduced section for use in a high-voltage switch. The aluminum contact with reduced section is composed of a base with a first thickness, an intermediate section with a second thickness, and an end section with a third thickness. The second thickness is smaller than the first and third thicknesses. The end section of the aluminum contact with reduced section can be a contact surface. The intermediate section acts in the same way as a spring element (which it is displaced). The aluminum contact can have multiple reduced sections in order to obtain the necessary path of the elastic deformation. In the case of multiple reduced sections, there will be more than 2 thicker sections. The aluminum contact with reduced section can have a circular base, and the intermediate section is formed by a number of contact pins with the necessary thickness. The aluminum contact with reduced section can have a curved intermediate section and its thickness is reduced as one draws closer to the end section. The contact can be produced by machining or extrusion. The contact can be used in a linear movement, radial movement, or any other type of movement or sliding. The contact can be fixed or movable in the electrical devices. The contact can be used with or without another type of outer galvanized surface or coating or sol id metallic coating of other metals. The contact can utilize the pressure of an additional spring or the elastic deformation of the contact material and an additional pressure spring are combined.

### BRIEF DESCRIPTION OF THE FIGURES

For a better understanding of the invention, a description shall be provided below, along with accompanying drawings, in which:

FIG. 1 is a three-dimensional model of one form of contact with a reduced section of the invention;

FIG. 2 is a model of the plastic deformation of the contact shown in FIG. 1;

FIG. 3 is a three-dimensional model of another embodiment of contact with a reduced section of the invention;

FIG. 4 is a model of the plastic deformation of the contact shown in FIG. 3;

FIG. 5 is a three-dimensional model of another embodiment of contact with a reduced section of the invention;

FIG. 6 is a model of the plastic deformation of the contact shown in FIG. 5;

FIG. 7 is a three-dimensional model of another embodiment of contact with a reduced section of the invention in the modality of a “D”;

FIG. 8 is a three-dimensional model of another embodiment of contact with a reduced section of the invention in the embodiment of a double “D”;

FIG. 9 is a three-dimensional model of another embodiment of contact with a reduced section of the invention;

FIG. 10 is a model of tubular tulip contact of aluminum with a reduced section of the invention;

FIG. 11 is a model of the plastic deformation of the contact shown in FIG. 10;

FIG. 12 is a model of tubular tulip contact of aluminum with a reduced section of the invention;

FIG. 13 is a model of the plastic deformation of the contact shown in FIG. 12;

FIG. 14 is a model of tubular tulip contact of aluminum with a reduced section of the invention;

FIG. 15 is a model of tubular tulip contact of aluminum with a reduced section of the invention;

FIG. 16 is a three-dimensional model of another embodiment of contact with a reduced section of the invention in the modality of a double “D”;

FIG. 17 is a model of tubular tulip contact of aluminum with a reduced section of the invention, assembled;

FIG. 18 is a model of tubular tulip contact of aluminum with a reduced section of the invention, disassembled;

FIG. 19 is a model of tubular tulip contact of aluminum with a reduced section of the invention, assembled; and

FIG. 20 is a model of tubular tulip contact of aluminum with a reduced section of the invention, disassembled.

### DETAILED DESCRIPTION OF THE INVENTION

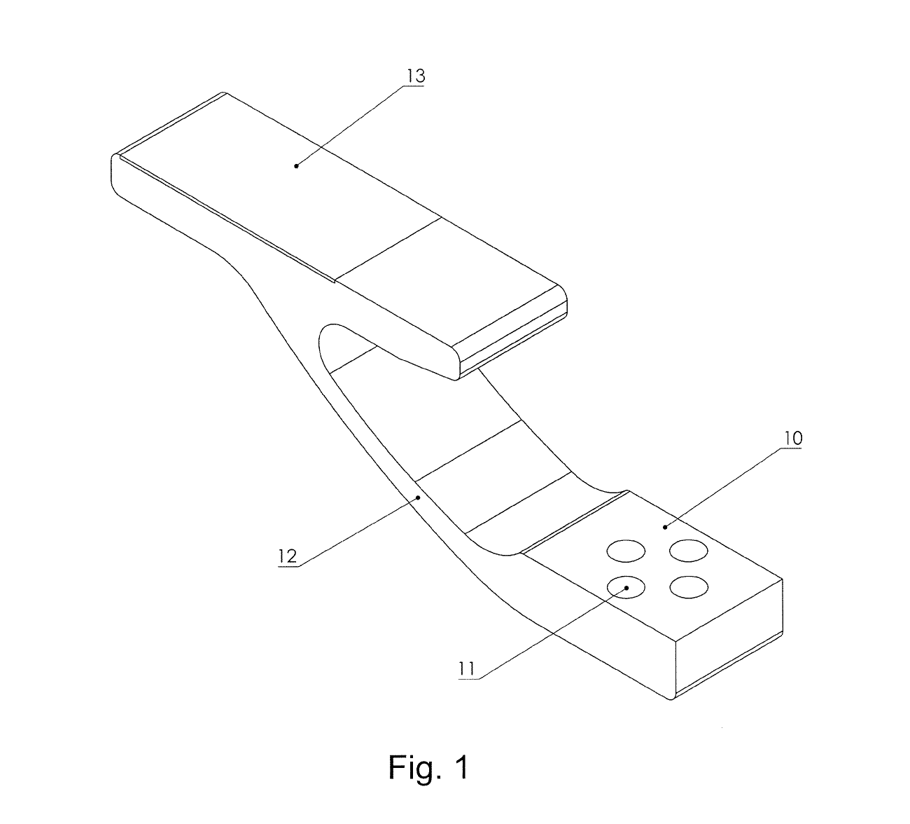

FIG. 1 shows one embodiment of the contact of the invention which includes a base (10), from which one intermediate section extends in the manner of a contact pin (12) with an end section which has a contact surface (13). The base (10) has perforations (11) to secure the contact to the isolating or disconnecting device. The intermediate section (12) has less thickness than the base (10) and the end section (13).

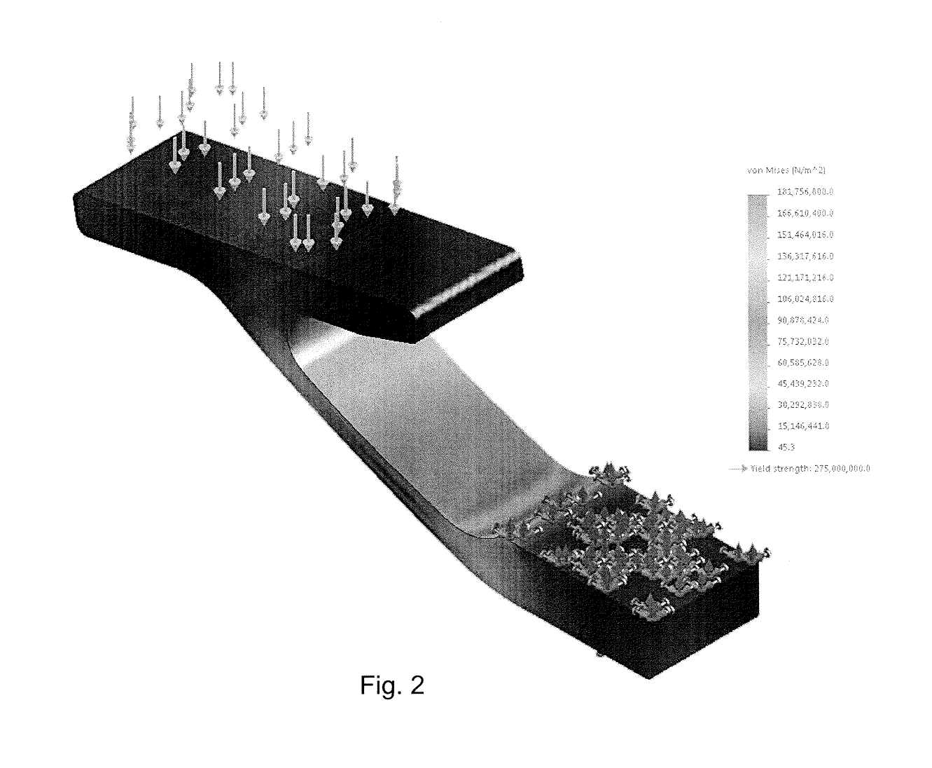

FIG. 2 shows a diagram of the plastic deformation of the contact of FIG. 1.

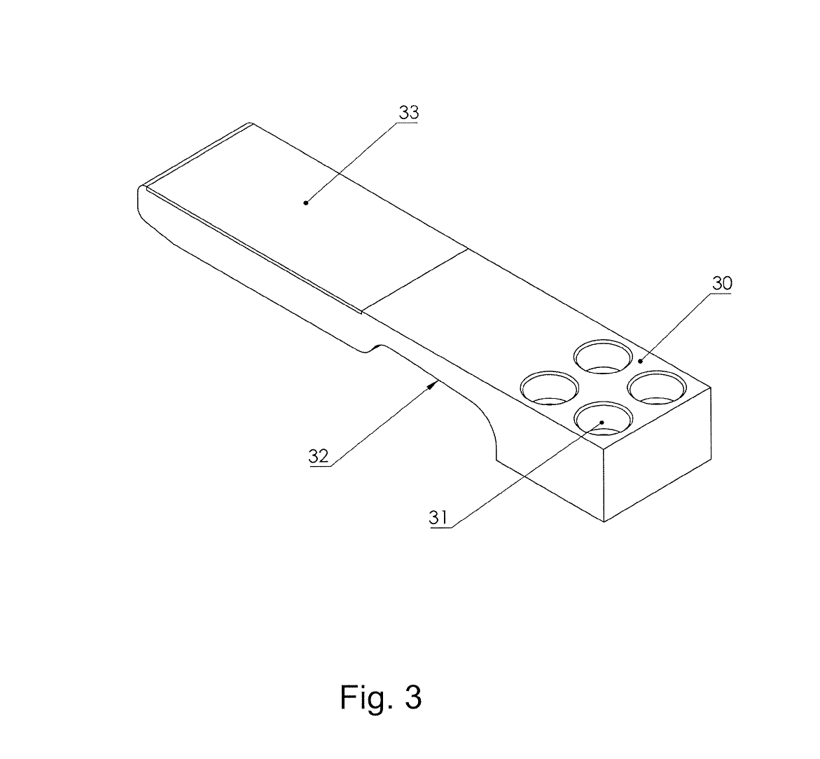

FIG. 3 is another embodiment of the contact of the invention, showing a base (30) from which extends an intermediate section (32) with perforations (3 1) to secure the contact to the isolating or disconnecting device. The intermediate section (32) has less thickness than the base (30) and the end section (33).

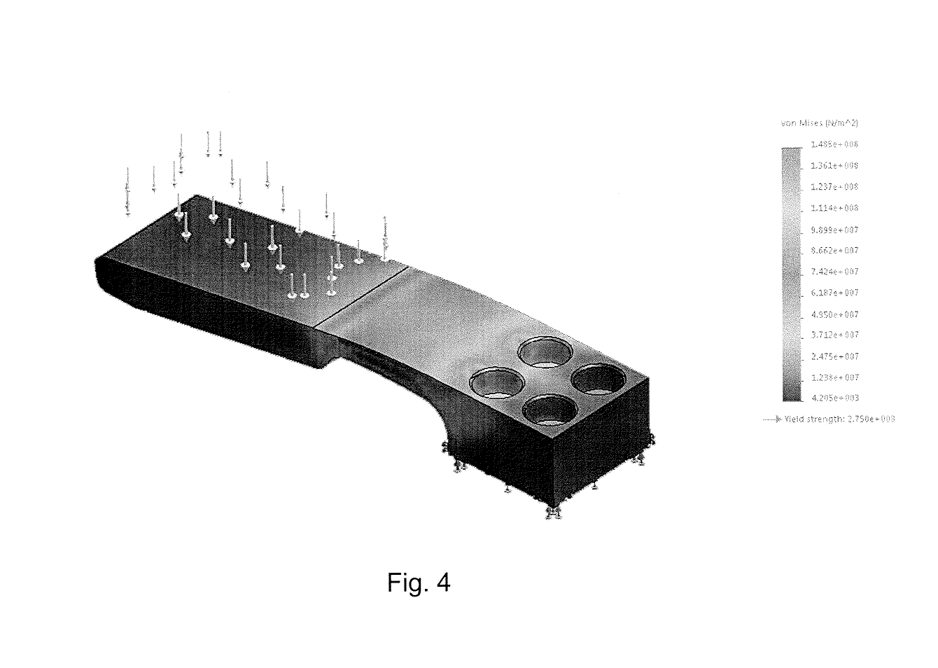

FIG. 4 shows a diagram of the plastic deformation of the contact of FIG. 3.

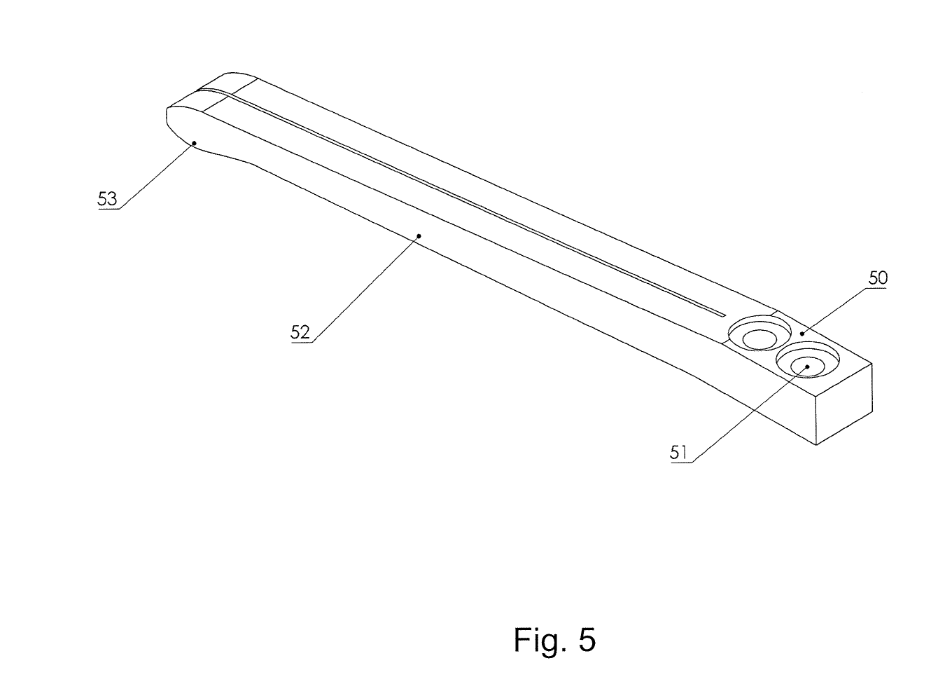

FIG. 5 is another embodiment of the contact of the invention, showing a base (50) from which extends an intermediate section (52) with an end section (53). The base (50) has perforations (51) to secure the contact to the isolating or disconnecting device. The intermediate section (52) has less thickness than the base (50) and the end section (53).

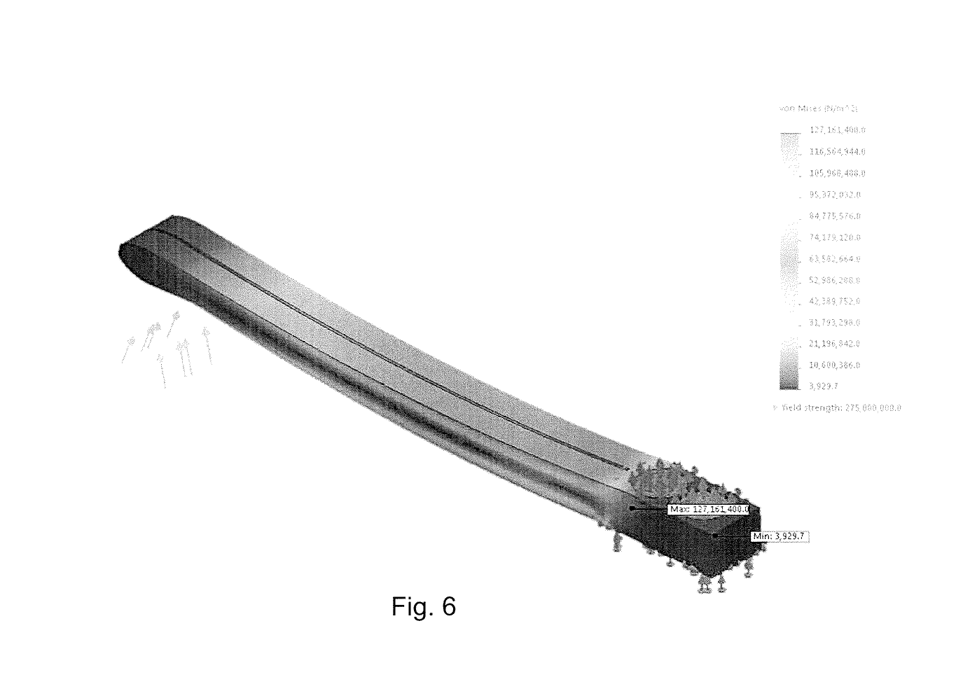

FIG. 6 shows the plastic deformation of the contact of FIG. 5.

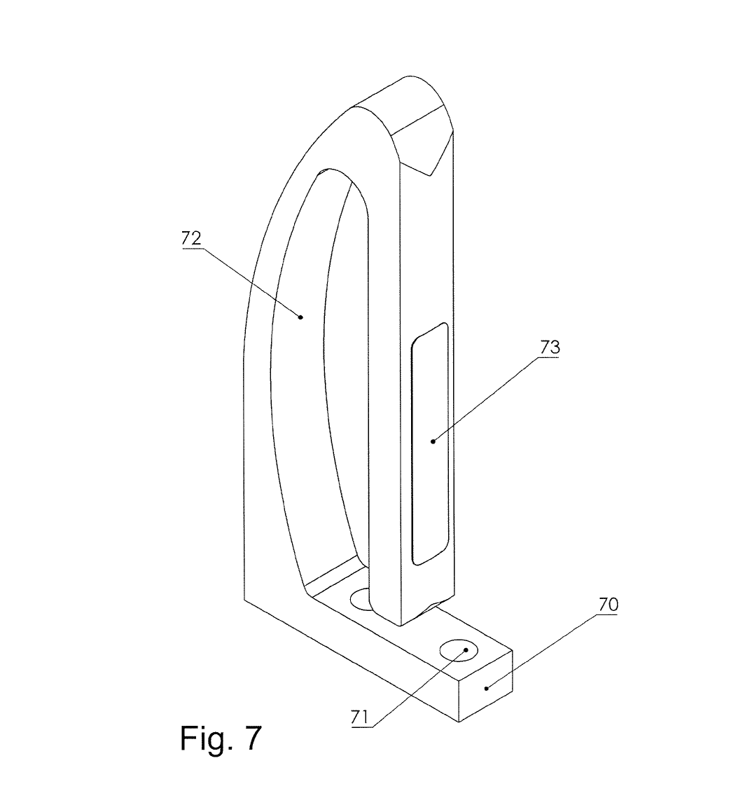

FIG. 7 is another embodiment of the contact of the invention, showing a base (70) from which extends an intermediate section (72) with an end section (73). The base (70) has perforations (71) to secure the contact to the isolating or disconnecting device. The intermediate section (72) is less thick than the base (70) and the end section (73).

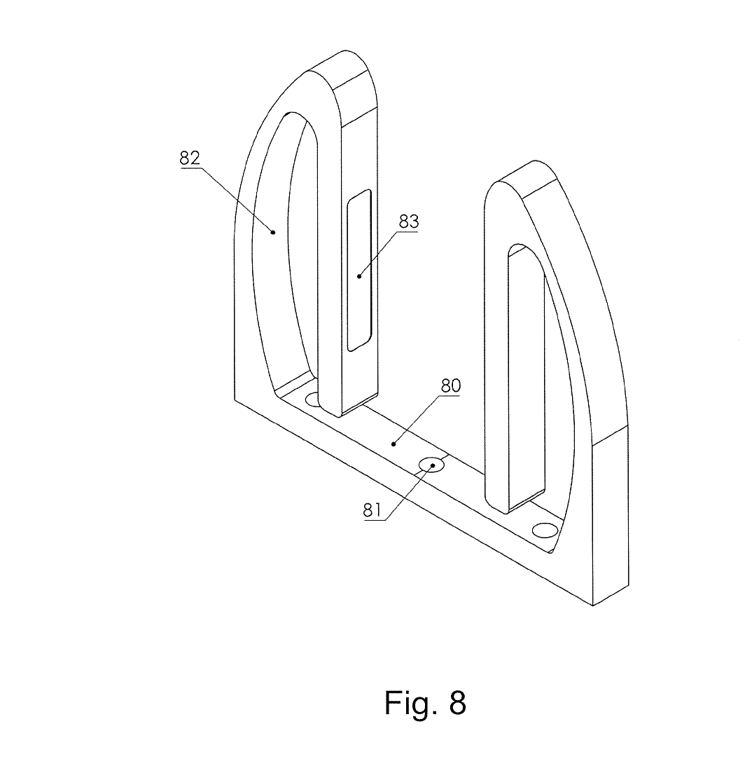

FIG. 8 is another embodiment of the contact of the invention, showing a base (80) from which extends an intermediate section (82) with perforations (81) to secure the contact to the isolating or disconnecting device. The intermediate section (82) has less thickness than the base (80) and the end section (83). The contact of this embodiment is composed of two contacts, one opposite the other.

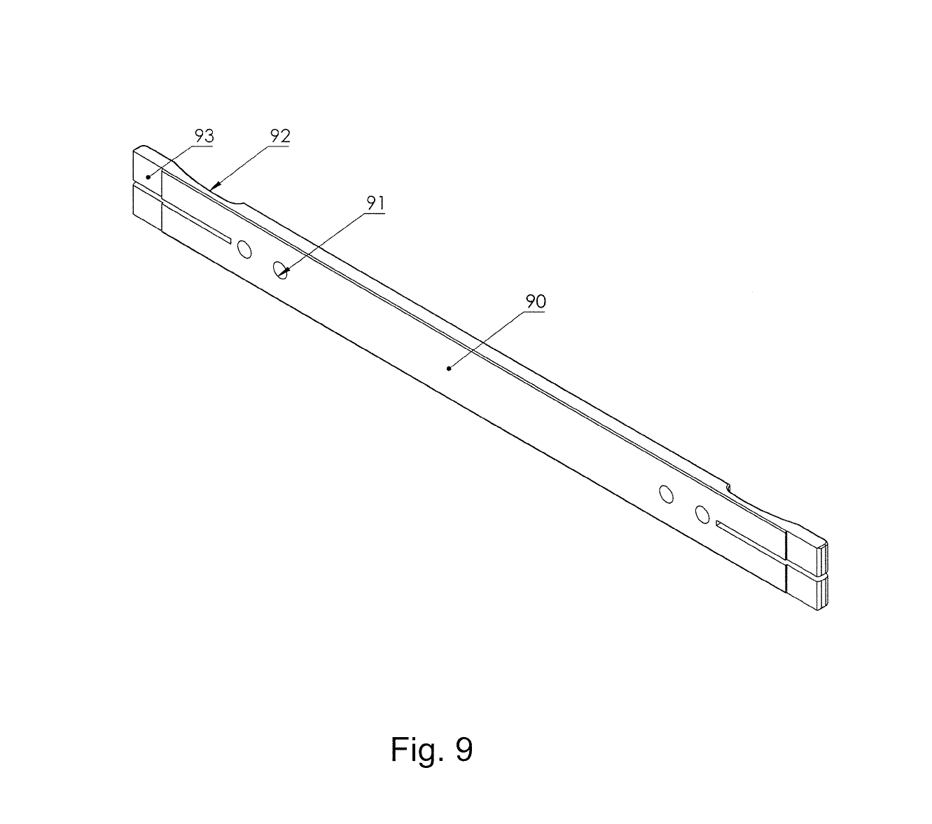

FIG. 9 is another embodiment of the contact of the invention, showing a base (90) from which extends an intermediate section (92) with perforations (91) to secure the contact to the isolating or disconnecting device. The intermediate section (92) has less thickness than the base (90) and the end section (93).

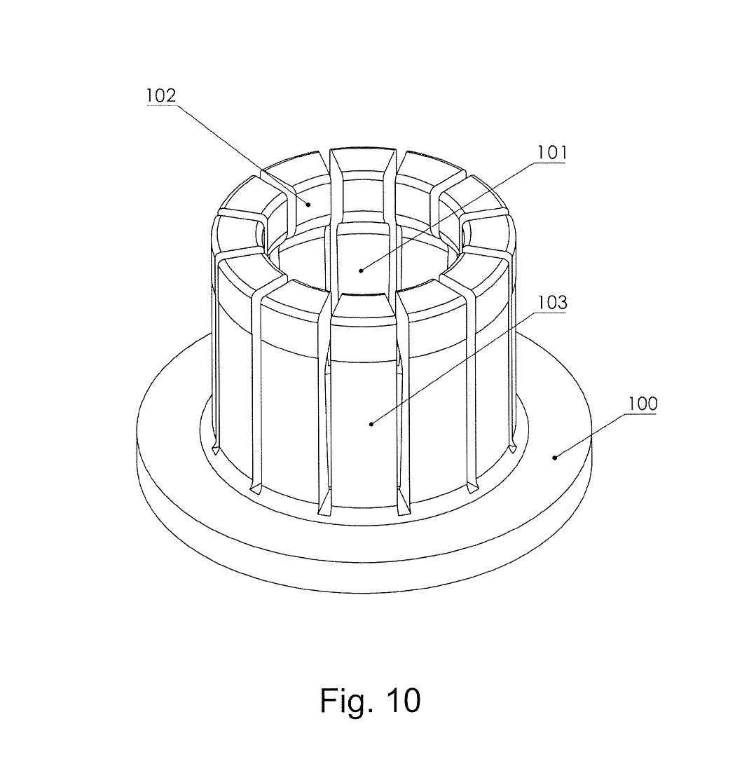

FIG. 10 is another embodiment of the contact of the invention, showing a base (100) from which extends an intermediate section (101) [with] an end section (102). The intermediate section (101) has less thickness than the base (TOO) and the end section (102). The electrical contact is designed to be reached outside the end section (102).

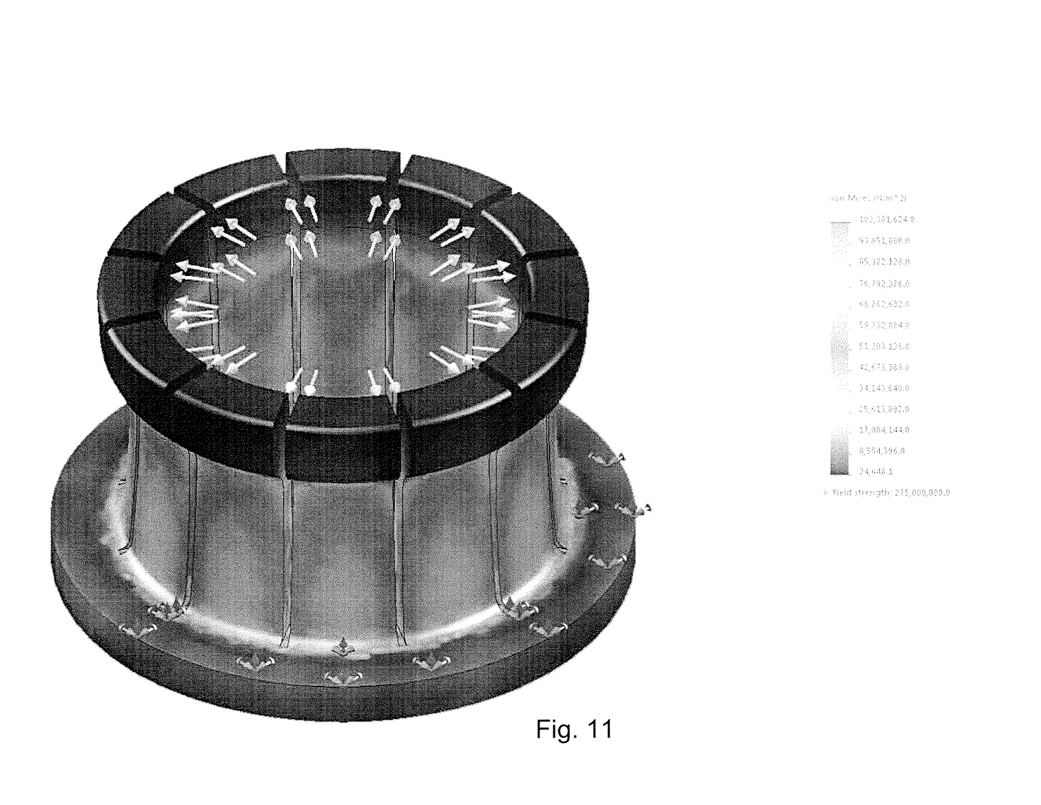

FIG. 11 shows a diagram of the plastic deformation of the contact of FIG. 10.

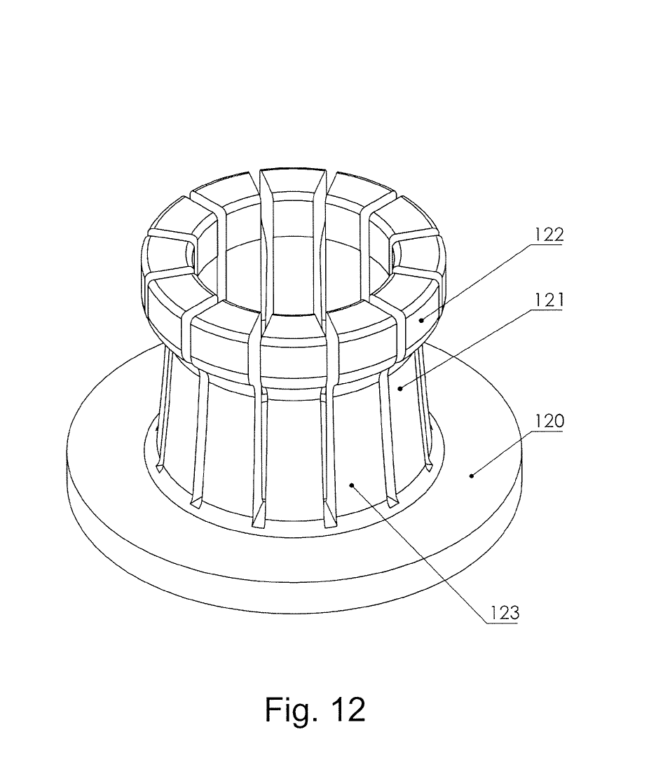

FIG. 12 is another embodiment of the contact of the invention, showing a circular extended base (120) from which extends an intermediate section (121) with an end section (122). A number of contact pins (123) extend from the base (120). The intermediate section (121) is less thick than the base (120) and the end section (122). The electrical contact is designed to be reached outside the end section (122).

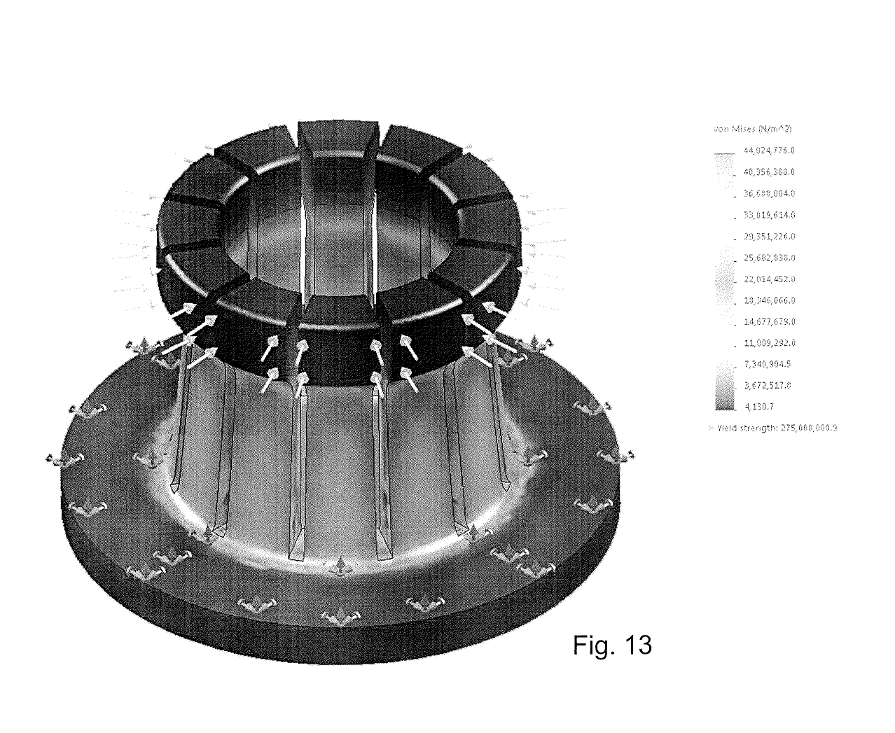

FIG. 13 shows a diagram of the plastic deformation of the contact of FIG. 12.

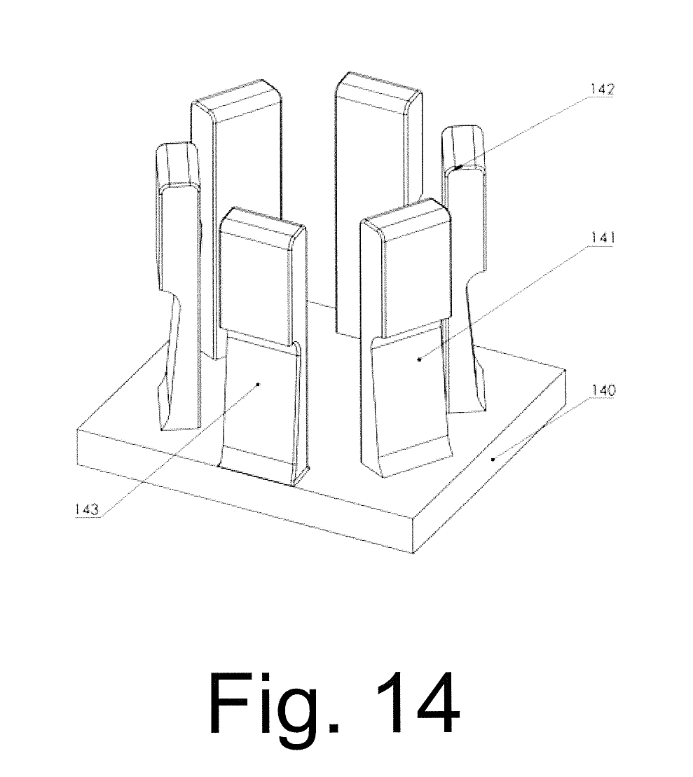

FIG. 14 is another embodiment of the contact of the invention, showing a square base (140) from which extends an intermediate section (141) with an end section (142). A number of contact pins (143) extend from the base (140). The intermediate section (141) is less thick than the base (140) and the end section (142). The electrical contact is designed to be reached outside the end section (142).

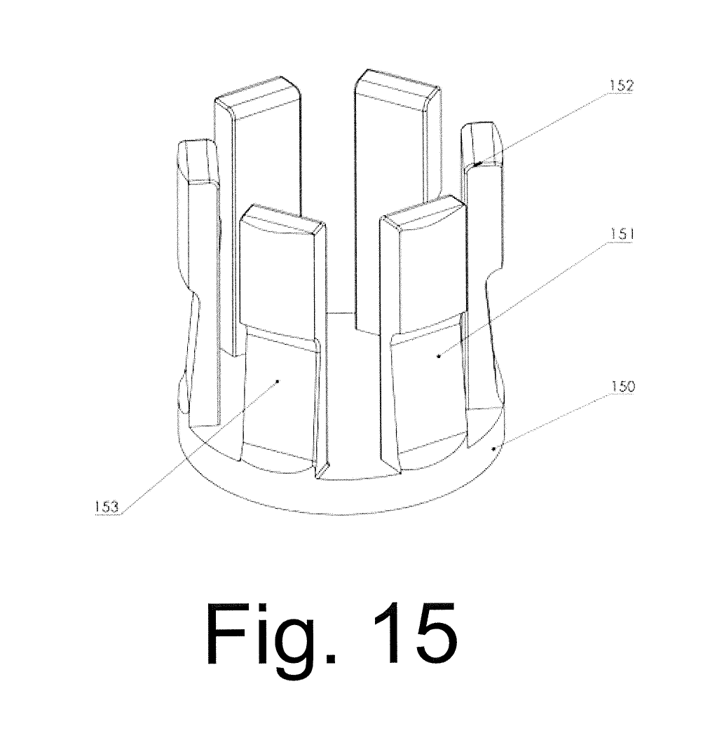

FIG. 15 is another embodiment of the contact of the invention, showing a circular base (150) from which extends an intermediate section (151) with an end section (152). A number of contact pins (153) extend from the base (150). The intermediate section (151) is less thick than the base (150) and the end section (152). The electrical contact is designed to be reached outside the end section (152).

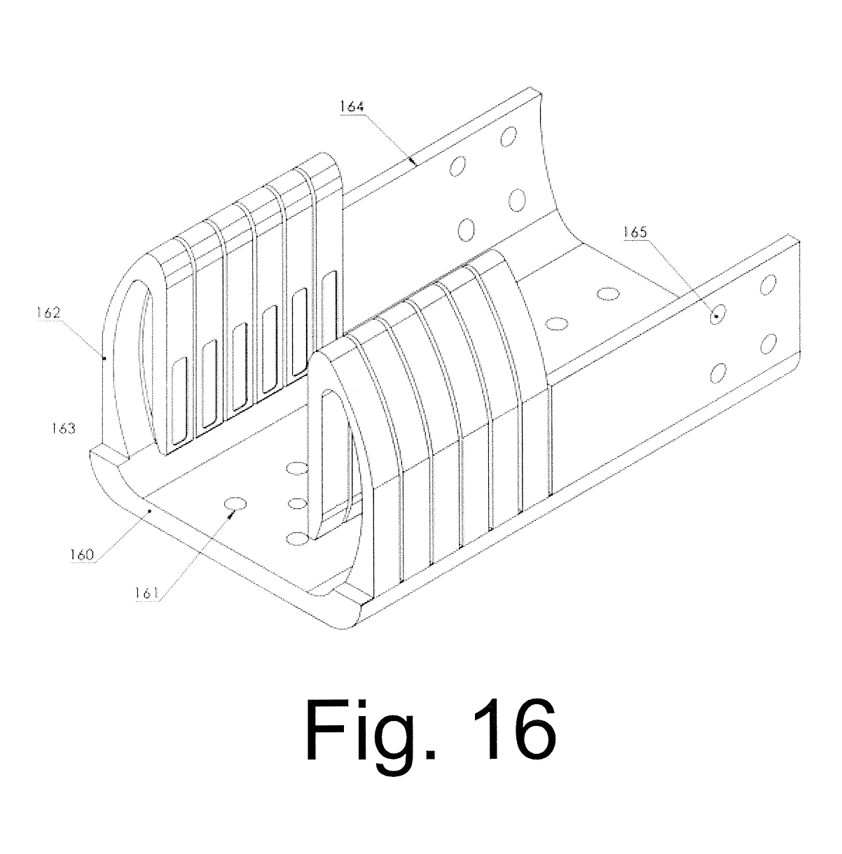

FIG. 16 is another embodiment of the contact of the invention, showing a base (160) from which extends an intermediate section (162) with perforations (161) to secure the contact to the isolating or disconnecting device. The intermediate section (162) has less thickness than the base (160) and the end section (163). The contact of this embodiment comprises a plurality of pairs of opposing contacts mounted on the base (160). There are two elements (164) which include perforations (165) to secure the contact to the switch.

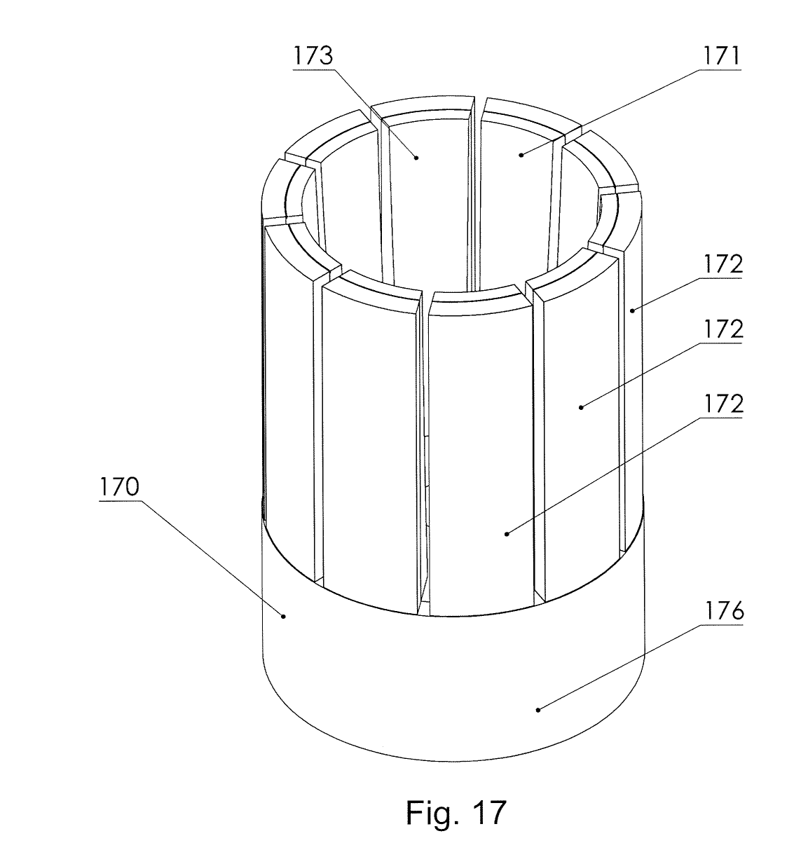

FIG. 17 is another embodiment of the contact of the invention in an assembled state, showing a copper base (170) from which extends an intermediate section (171) with an end section (173). A number of contact pins (172) extend from the base (176). The intermediate section (171) is less thick than the base (171) and the end section (173).

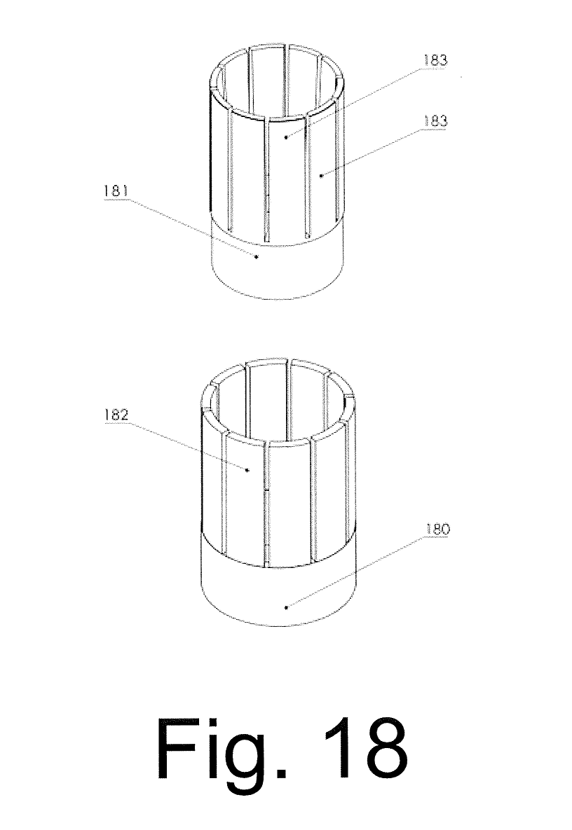

FIG. 18 shows the contact of FIG. 17 in a disassembled state, illustrating the contact (180) and (181), the pins (182) and the intermediate section (183).

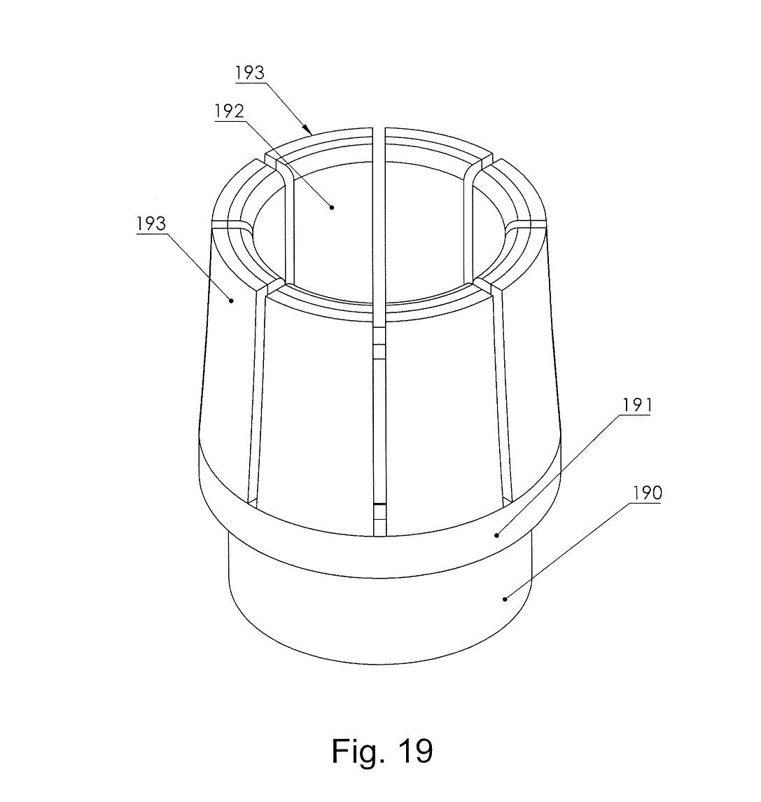

FIG. 19 is another embodiment of the contact of the invention in an assembled state, showing a copper base (190) from which extends an intermediate section (191) with an end section (193). A number of contact pins (192) extend from the base (190). The intermediate section (191) is less thick than the base (190) and the end section (193).

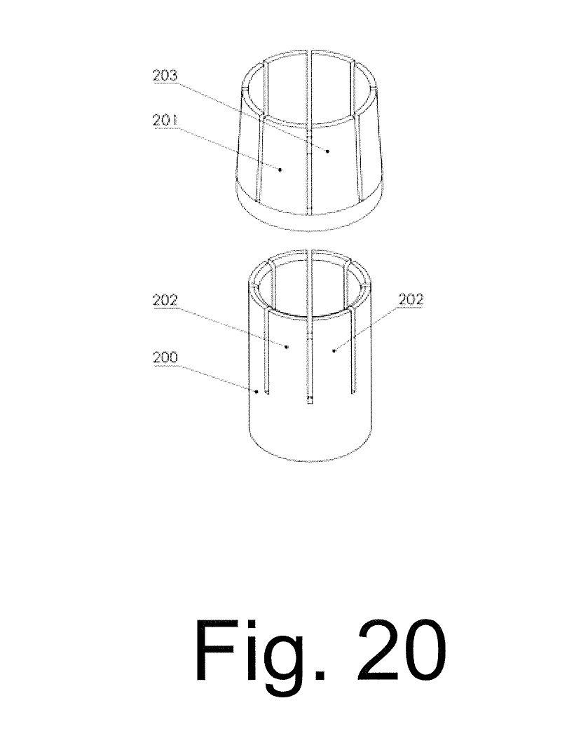

FIG. 20 shows the contact of FIG. 19 in a disassembled state, illustrating the contact (200) and (201), the pins (202) and the intermediate section (203).

Even though the invention has been illustrated and described in detail in the drawings and the preceding description, this illustration and this description should be considered an example and not of a limiting nature. Consequently, it should be understood that there has only be shown the preferred embodiment and that all the changes and modifications which fall within the spirit of the invention are to be protected on the basis of the following claims.

1. An electrical contact with reduced section for use as a component of a high-voltage switch, the contact with reduced section comprises a base with a first thickness, at least one intermediate section with a second thickness that is associated with an end section with a third thickness, the second thickness is smaller than the first and third thicknesses.

2. Contact according to claim 1, in which the end section is a contact surface.

3. Contact according to claim 1, in which the at least one intermediate section acts like a spring element.

4. Contact according to claim 1, in which the circular base and the at least one intermediate section are comprised of a number of contact pins of the second thickness.

5. Contact according to claim 1, in which the intermediate section is curved and its thickness is reduced as one comes closer to the end section.

6. Contact according to claim 1, in which the contact is produced by machining or extrusion.

7. Contact according to claim 1, in which the contact is used in a linear movement, in a radial movement, or any other type of movement of sliding.

8. Contact according to claim 1, in which the contact can be fixed or movable in electrical devices.

9. Contact according to claim 1, in which the contact can be used with or without another type of external coating or galvanized surface of solid metallic coating of other metals.

10. Contact according to claim 1, in which the contact is used with the pressure of an additional spring or combines the elastic deformation of the contact material and the pressure of the additional spring.

11. An electrical contact with reduced section for use as a component of a high-voltage switch, the contact with reduced section comprises a base with a first thickness and an intermediate section with a second thickness, the second thickness being less than the first thickness.

12. Contact according to claim 11, in which the base is rectangular and the intermediate section is formed by a number of contact pins of second thickness, positioned in angular configuration, and designed to operate with rotation contacts, or as a sliding contact against a multifaceted and circular contact.

13. Contact according to claim 11, in which the base is round and the intermediate section is formed by a number of contact pins of second thickness, positioned in angular configuration, and designed to operate with rotation contacts, or as a sliding contact against a multifaceted and circular contact.

14. Contact according to claim 11, in which all the contact pins are an integral part of the contact assembly being produced by extrusion and the contacts are separated by machining into individual contacts.
